(19) United States
(12) Patent Application Publication
(10) Pub. No.: US 2026/0058777 A1
(43) Pub. Date: Feb. 26, 2026

(54) MAPPING SOUNDING REFERENCE SIGNAL PORTS TO A QUANTITY OF SYMBOLS

(71) Applicant: QUALCOMM Incorporated, San Diego, CA (US)

(72) Inventors: Kexin XIAO, Shanghai (CN); Yi HUANG, San Diego, CA (US); Wanshi CHEN, San Diego, CA (US); Yu ZHANG, San Diego, CA (US); Muhammad Sayed Khairy ABDELGHAFFAR, San Jose, CA (US)

(21) Appl. No.: 19/100,096

(22) PCT Filed: Sep. 22, 2022
(86) PCT No.: PCT/CN2022/120433

§ 371 Date: Jan. 30, 2025

(51) Int. Cl. H04L 5/00

(52) U.S. Cl. CPC H04L 5/0051; H04L 5/0007

(57) ABSTRACT

Various aspects of the present disclosure generally relate to wireless communication. In some aspects, a user equipment (UE) may receive, from a network node, a time domain pattern configuration that indicates a quantity of orthogonal frequency division multiplexing (OFDM) symbols for mapping 8 sounding reference signal (SRS) ports in an SRS resource. The UE may transmit, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration. Numerous other aspects are described.

### FIELD OF THE DISCLOSURE

Aspects of the present disclosure generally relate to wireless communication and to techniques and apparatuses for mapping sounding reference signal (SRS) ports to a quantity of symbols.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network node, a time domain pattern configuration that indicates a quantity of orthogonal frequency division multiplexing (OFDM) symbols for mapping 8 sounding reference signal (SRS) ports in an SRS resource; and transmit, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

In some implementations, an apparatus for wireless communication at a network node includes a memory and one or more processors, coupled to the memory, configured to: transmit, to a UE, a time domain pattern configuration that indicates a quantity of OFDM symbols for mapping 8 SRS ports in an SRS resource; and receive, from the UE, an SRS based at least in part on the time domain pattern configuration, wherein the SRS is received based at least in part on the 8 SRS ports in the SRS resource being mapped to the quantity of OFDM symbols according to the time domain pattern configuration.

In some implementations, a method of wireless communication performed by an apparatus of a UE includes receiving, from a network node, a time domain pattern configuration that indicates a quantity of OFDM symbols for mapping 8 SRS ports in an SRS resource; and transmitting, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

In some implementations, a method of wireless communication performed by an apparatus of a network node includes transmitting, to a UE, a time domain pattern configuration that indicates a quantity of OFDM symbols for mapping 8 SRS ports in an SRS resource; and receiving, from the UE, an SRS based at least in part on the time domain pattern configuration, wherein the SRS is received based at least in part on the 8 SRS ports in the SRS resource being mapped to the quantity of OFDM symbols according to the time domain pattern configuration.

In some implementations, a non-transitory computer-readable medium storing a set of instructions for wireless communication includes one or more instructions that, when executed by one or more processors of a UE, cause the UE to: receive, from a network node, a time domain pattern configuration that indicates a quantity of OFDM symbols for mapping 8 SRS ports in an SRS resource; and transmit, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

In some implementations, a non-transitory computer-readable medium storing a set of instructions for wireless communication includes one or more instructions that, when executed by one or more processors of a network node, cause the network node to: transmit, to a UE, a time domain pattern configuration that indicates a quantity of OFDM symbols for mapping 8 SRS ports in an SRS resource; and receive, from the UE, an SRS based at least in part on the time domain pattern configuration, wherein the SRS is received based at least in part on the 8 SRS ports in the SRS resource being mapped to the quantity of OFDM symbols according to the time domain pattern configuration.

In some implementations, an apparatus for wireless communication includes means for receiving, from a network node, a time domain pattern configuration that indicates a quantity of OFDM symbols for mapping 8 SRS ports in an SRS resource; and means for transmitting, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

In some implementations, an apparatus for wireless communication includes means for transmitting, to a UE, a time domain pattern configuration that indicates a quantity of OFDM symbols for mapping 8 SRS ports in an SRS resource; and means for receiving, from the UE, an SRS based at least in part on the time domain pattern configuration, wherein the SRS is received based at least in part on the 8 SRS ports in the SRS resource being mapped to the quantity of OFDM symbols according to the time domain pattern configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sounding reference signal (SRS) resource sets, in accordance with the present disclosure.

FIG. 5 is a diagram illustrating an example of a codebook-based uplink transmission procedure, in accordance with the present disclosure.

FIG. 6 is a diagram illustrating an example of a SRS port mapping, in accordance with the present disclosure.

FIG. 7 is a diagram illustrating an example of an SRS frequency hopping, in accordance with the present disclosure.

FIGS. 8-9 are diagrams illustrating examples associated with mapping SRS ports to a quantity of symbols, in accordance with the present disclosure.

FIGS. 10-11 are diagrams illustrating example processes associated with mapping SRS ports to a quantity of symbols, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

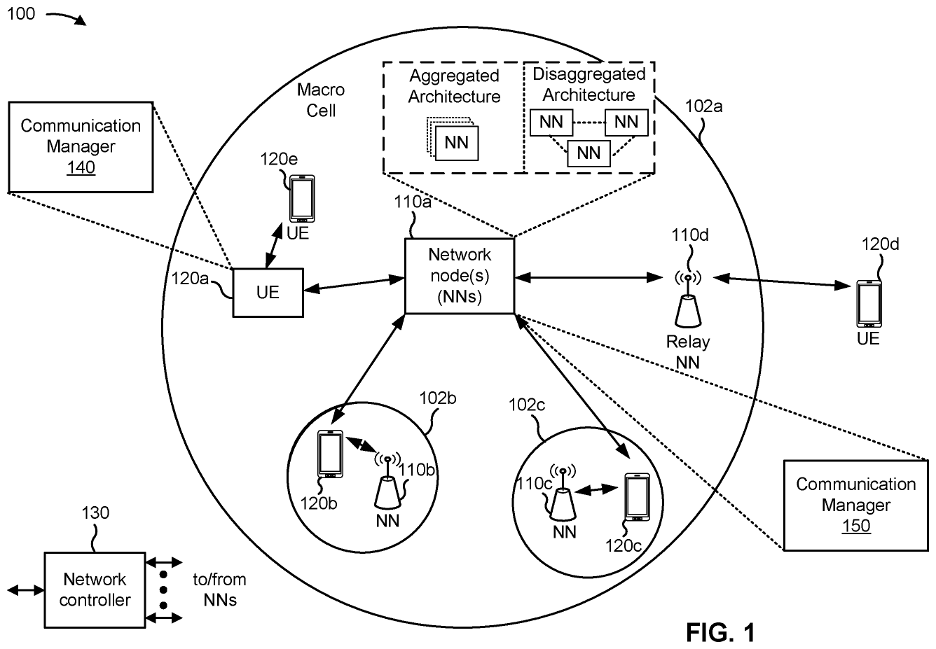

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, a time domain pattern configuration that indicates a quantity of orthogonal frequency division multiplexing (OFDM) symbols for mapping 8 sounding reference signal (SRS) ports in an SRS resource; and transmit, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a time domain pattern configuration that indicates a quantity of OFDM symbols for mapping 8 SRS ports in an SRS resource; and receive, from the UE, an SRS based at least in part on the time domain pattern configuration, wherein the SRS is received based at least in part on the 8 SRS ports in the SRS resource being mapped to the quantity of OFDM symbols according to the time domain pattern configuration. Additionally, or alternatively, the communication manager 150 may perform one or more other operations described herein.

As indicated above, FIG. 1 is provided as an example. Other examples may differ from what is described with regard to FIG. 1.

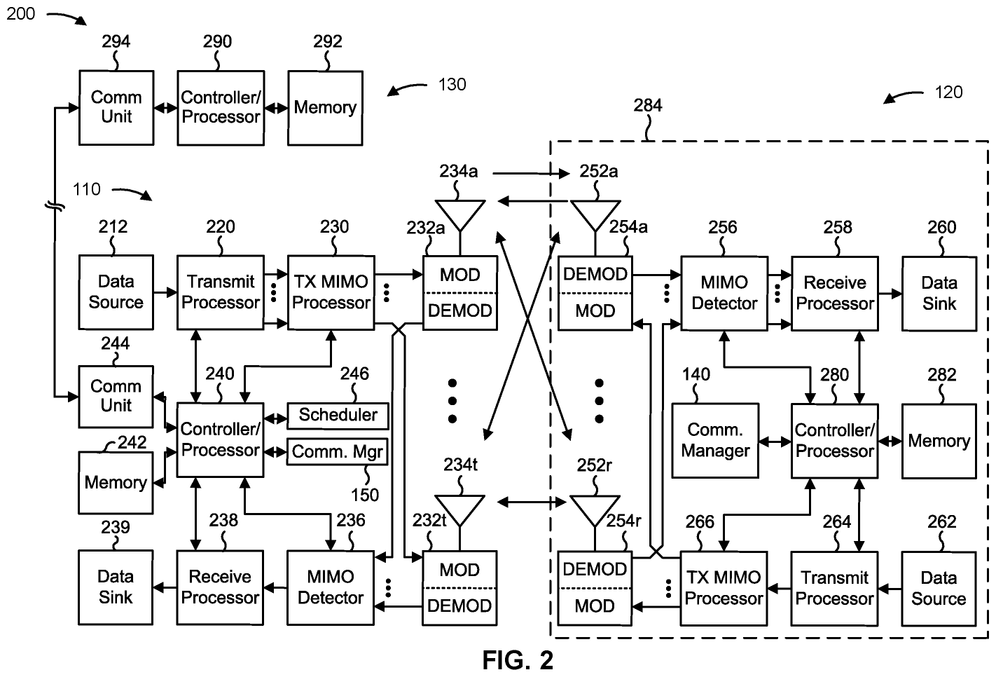

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

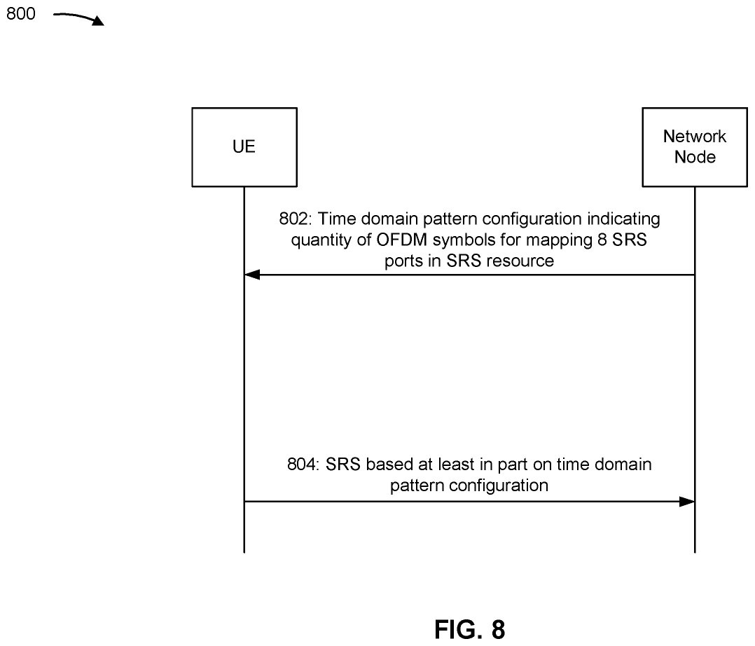

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a Tx MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the Tx MIMO processor 266. The transceiver may be used by a processor (e.g., the controller/processor 280) and the memory 282 to perform aspects of any of the methods described herein (e.g., with reference to FIGS. 8-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the Tx MIMO processor 230. The transceiver may be used by a processor (e.g., the controller/processor 240) and the memory 242 to perform aspects of any of the methods described herein (e.g., with reference to FIGS. 8-13).

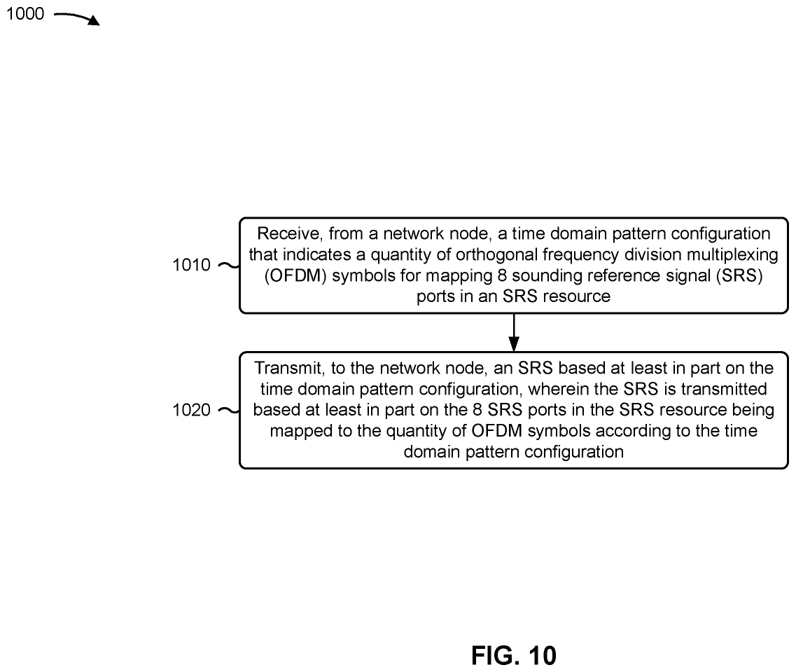

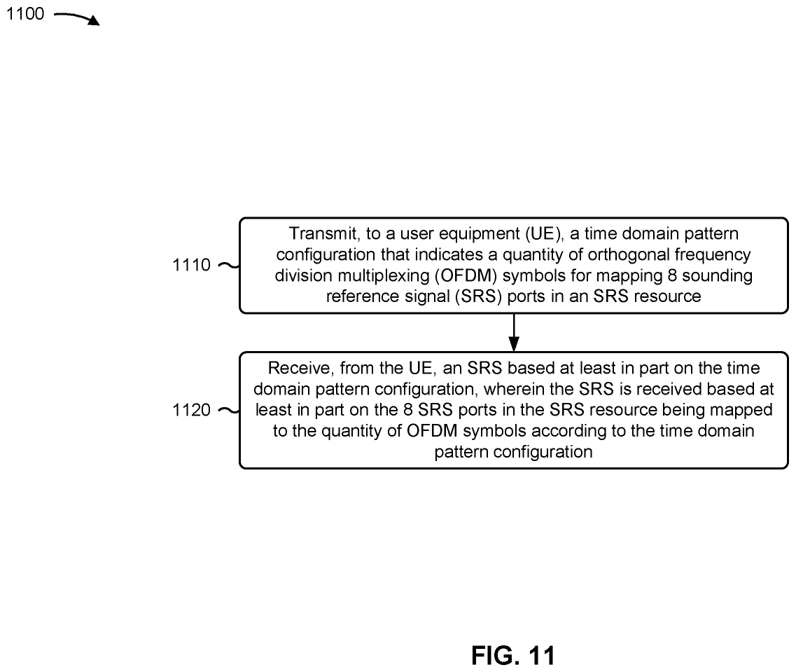

The controller/processor 240 of the network node 110, the controller/processor 280 of the UE 120, and/or any other component(s) of FIG. 2 may perform one or more techniques associated with mapping SRS ports to a quantity of symbols, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node, a time domain pattern configuration that indicates a quantity of OFDM symbols for mapping 8 SRS ports in an SRS resource; and/or means for transmitting, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration. In some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, a time domain pattern configuration that indicates a quantity of OFDM symbols for mapping 8 SRS ports in an SRS resource; and/or means for receiving, from the UE, an SRS based at least in part on the time domain pattern configuration, wherein the SRS is received based at least in part on the 8 SRS ports in the SRS resource being mapped to the quantity of OFDM symbols according to the time domain pattern configuration. In some aspects, the means for the apparatus to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the Tx MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

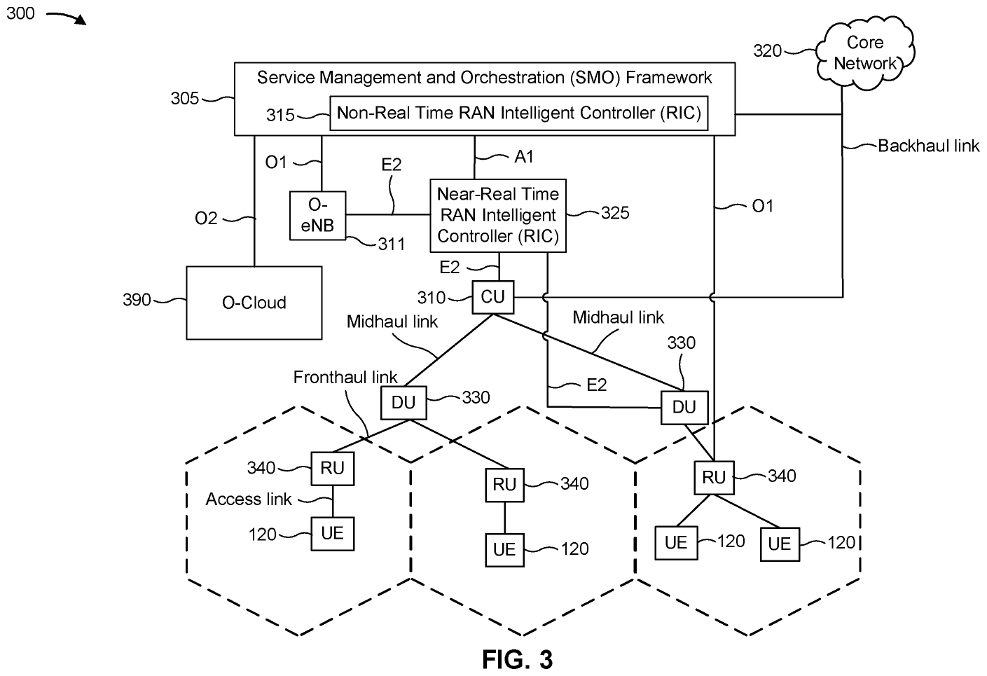

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

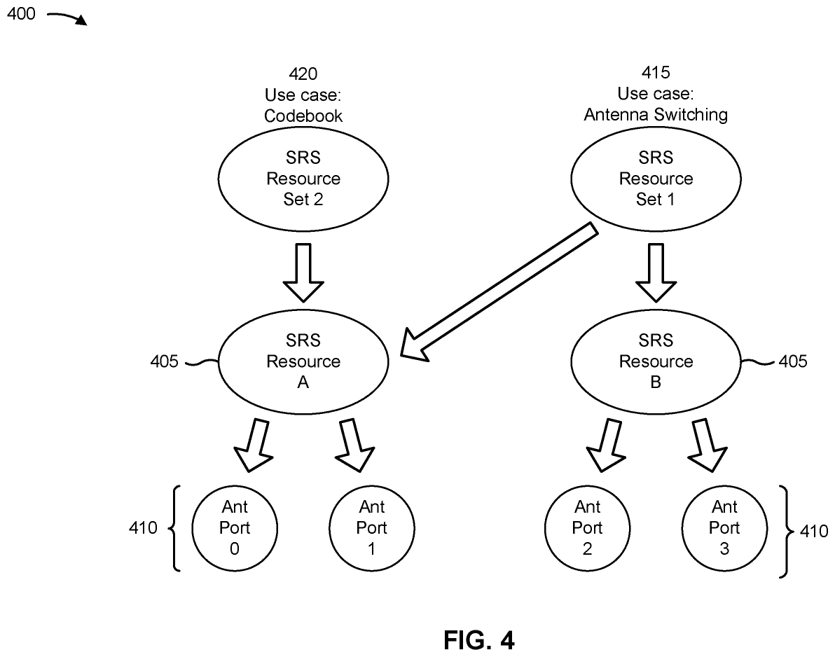

FIG. 4 is a diagram illustrating an example 400 of SRS resource sets, in accordance with the present disclosure.

A UE may be configured with one or more SRS resource sets to allocate resources for SRS transmissions by the UE. For example, a configuration for SRS resource sets may be indicated in an RRC message (e.g., an RRC configuration message or an RRC reconfiguration message). As shown by reference number 405, an SRS resource set may include one or more resources (e.g., shown as SRS resources), which may include time resources and/or frequency resources (e.g., a slot, a symbol, a resource block, and/or a periodicity for the time resources).

As shown by reference number 410, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink channel state information (CSI) with reciprocity between an uplink and downlink channel. For example, when there is reciprocity between an uplink channel and a downlink channel, a network node may use an antenna switching SRS (e.g., an SRS transmitted using a resource of an antenna switching SRS resource set) to acquire downlink CSI (e.g., to determine a downlink precoder to be used to communicate with the UE).

A codebook SRS resource set may be used to indicate uplink CSI when a network node indicates an uplink precoder to the UE. For example, when the network node is configured to indicate an uplink precoder to the UE (e.g., using a precoder codebook), the network node may use a codebook SRS (e.g., an SRS transmitted using a resource of a codebook SRS resource set) to acquire uplink CSI (e.g., to determine an uplink precoder to be indicated to the UE and used by the UE to communicate with the network node). In some aspects, virtual ports (e.g., a combination of two or more antenna ports) with a maximum transmit power may be supported at least for a codebook SRS.

A non-codebook SRS resource set may be used to indicate uplink CSI when the UE selects an uplink precoder (e.g., instead of the network node indicated an uplink precoder to be used by the UE). For example, when the UE is configured to select an uplink precoder, the network node may use a non-codebook SRS (e.g., an SRS transmitted using a resource of a non-codebook SRS resource set) to acquire uplink CSI. In this case, the non-codebook SRS may be precoded using a precoder selected by the UE (e.g., which may be indicated to the network node).

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using downlink control information (DCI) or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE may be configured with a mapping between SRS ports (e.g., antenna ports) and corresponding SRS resources. The UE may transmit an SRS on a particular SRS resource using an SRS port indicated in the configuration. In some aspects, an SRS resource may span N adjacent symbols within a slot (e.g., where N equals 1, 2, or 4). The UE may be configured with X SRS ports (e.g., where X≤4). In some aspects, each of the X SRS ports may mapped to a corresponding symbol of the SRS resource and used for transmission of an SRS in that symbol.

As shown in FIG. 4, in some aspects, different SRS resource sets indicated to the UE (e.g., having different use cases) may overlap (e.g., in time and/or in frequency, such as in the same slot). For example, as shown by reference number 415, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 420, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE may not transmit codebook SRSs in SRS Resource B (e.g., the second time-frequency resource) using antenna port 2 and antenna port 3.

As indicated above, FIG. 4 is provided as an example. Other examples may differ from what is described with regard to FIG. 4.

In a MIMO design, an uplink DMRS, SRS, SRS resource indicator (SRI), or transmit precoder matrix indicator (TPMI) (including codebook) signaling may be specified to enable an 8 Tx uplink operation (e.g., 8 Tx chains in an uplink). In the MIMO design, four or more layers may be supported per UE in an uplink. The MIMO design may target customer premise equipment (CPE), fixed wireless access (FWA) devices, vehicles, and/or industrial devices.

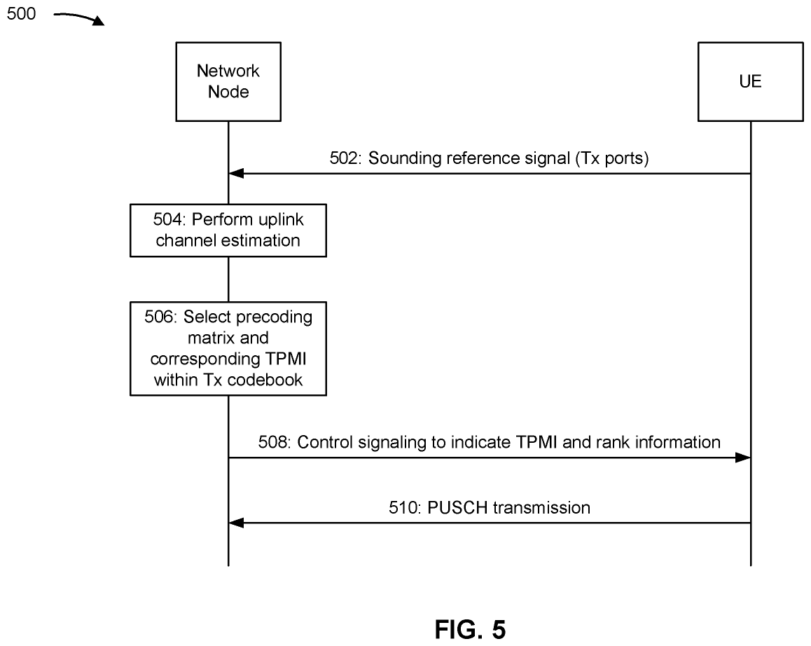

FIG. 5 is a diagram illustrating an example 500 of a codebook-based uplink transmission procedure, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

As shown by reference number 502, the UE may transmit an SRS to the network node. The UE may transmit the SRS using one or more Tx ports. As shown by reference number 504, the network node may perform an uplink channel estimation based at least in part on the SRS received from the UE. As shown by reference number 506, the network node may select a precoding matrix and a corresponding TPMI within a Tx codebook, where the precoding matrix and the corresponding TPMI may be selected based at least in part on the uplink channel estimation. As shown by reference number 508, the network node may transmit control signaling to the UE. The control signaling may indicate the TPMI and rank information. As shown by reference number 510, the UE may transmit a physical uplink shared channel (PUSCH) transmission to the network node. The PUSCH transmission may be based at least in part on the control signaling received from the network node (e.g., the TPMI and the rank information).

As indicated above, FIG. 5 is provided as an example. Other examples may differ from what is described with regard to FIG. 5.

One, two, or four ports may be allowed per SRS resource. One SRS port may be mapped to a comb on a OFDM symbol (e.g., one comb on one OFDM symbol). The one SRS port may be mapped to the comb via RRC signaling from a network node. An SRS sequence may be transmitted on the comb and the OFDM symbol with a certain cyclic shift. A cyclic shift for an SRS port

$$( {n}_{SRS}^{cs , i} )$$

may depend on a port index (pᵢ), a number of antenna ports per SRS resource

$$( {N}_{ap}^{SRS} ) ,$$

and a maximum number of cyclic shifts for an SRS port

$$( {n}_{SRS}^{cs , max} ) ,$$

and may be calculated using the following:

$${n}_{SRS}^{cs , i} = \{ \begin{matrix}( {n}_{SRS}^{cs} + \frac{{n}_{SRS}^{cs , max} ⌊ ( {p}_{i} - 1000 ) / 2 ⌋}{{N}_{ap}^{SRS} / 2} ) mod {n}_{SRS}^{cs , max} & if {N}_{ap}^{SRS} = 4 and {n}_{SRS}^{cs , max} = 6 \\ ( {n}_{SRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix} .$$

Two SRS ports may be associated with one comb and two cyclic shifts. Four SRS ports may be associated with one comb and four cyclic shifts, or four SRS ports may be associated with two combs and two cyclic shifts.

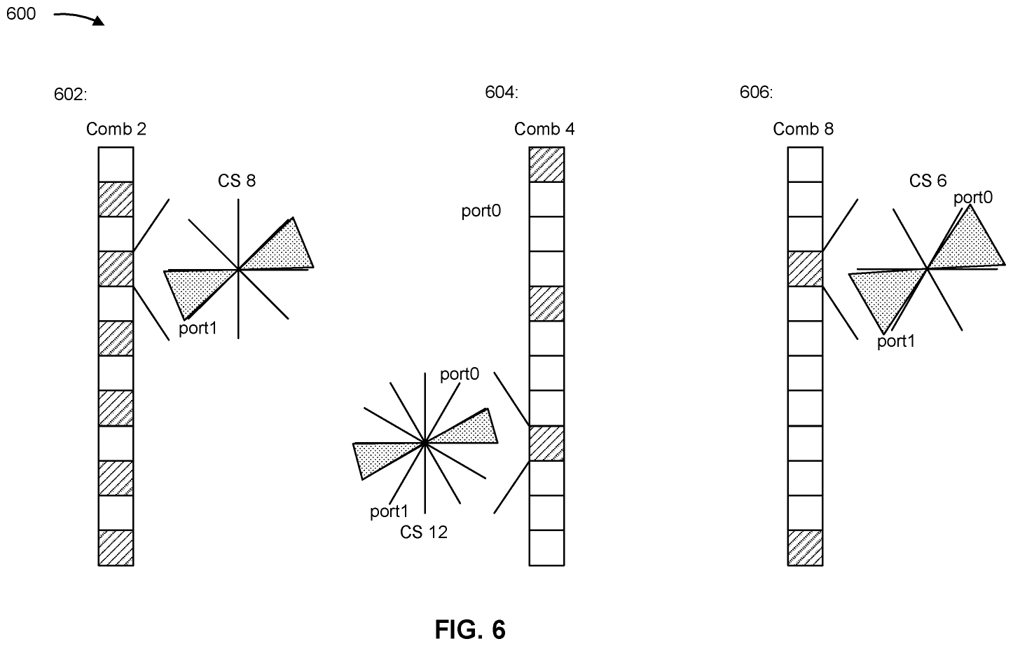

FIG. 6 is a diagram illustrating an example 600 of an SRS port mapping, in accordance with the present disclosure.

As shown by reference number 602, an SRS port mapping may be defined for two ports per SRS resource

$$( e . g . , {N}_{ap}^{SRS} = 2 )$$

(e.g., port 0 and port 1) and for two combs (e.g., K_{TC}=2), and may be associated with a maximum number of cyclic shifts of 8

$$( e . g . , {N}_{SRS}^{cs , max} = 8 ) ,$$

where K_{TC} is the transmission comb number. As shown by reference number 604, an SRS port mapping may be defined for two ports per SRS resource

$$( e . g . , {N}_{ap}^{SRS} = 2 )$$

and for four combs (e.g., K_{TC}=4), and may be associated with a maximum number of cyclic shifts of 12

$$( e . g . , {N}_{SRS}^{cs , max} = 12 ) .$$

As shown by reference number 606, an SRS port mapping may be defined for two ports per SRS resource

$$( e . g . , {N}_{ap}^{SRS} = 2 )$$

and for 8 combs (e.g., K_{TC}=8), and may be associated with a maximum number of cyclic shifts of 6

$$( e . g . , {N}_{SRS}^{cs , max} = 6 ) .$$

As indicated above, FIG. 6 is provided as an example. Other examples may differ from what is described with regard to FIG. 6.

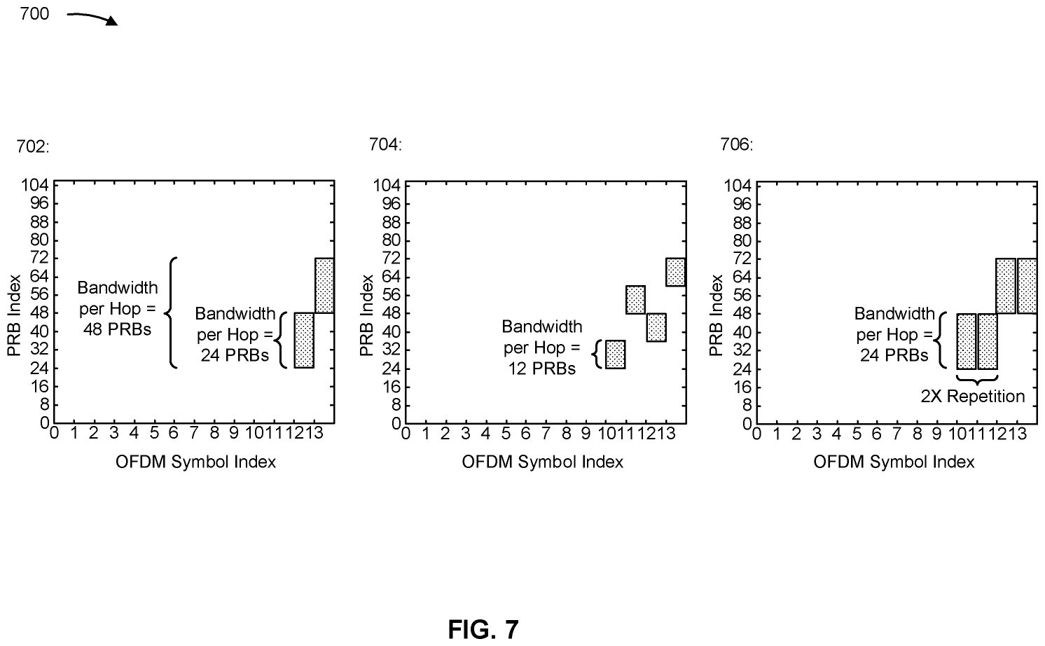

FIG. 7 is a diagram illustrating an example 700 of an SRS frequency hopping, in accordance with the present disclosure.

An SRS (e.g., one SRS resource) with frequency hopping/repetition may span 48 physical resource blocks (PRBs). The SRS may be associated with a PRB index and an OFDM symbol index. As shown by reference number 702, a sounding bandwidth may be 48 PRBs, which may be based at least in part on a bandwidth per hop of 24 PRBs. As shown by reference number 704, a sounding bandwidth may be 48 PRBs, which may be based at least in part on a bandwidth per hop of 12 PRBs. As shown by reference number 706, a sounding bandwidth may be 48 PRBs, which may be based at least in part on a bandwidth per hop of 24 PRBs and a times two (e.g., 2π) repetition.

As indicated above, FIG. 7 is provided as an example. Other examples may differ from what is described with regard to FIG. 7.

An SRS frequency resource configuration may depend on whether frequency hopping is enabled or disabled. A frequency hopping of an SRS may be configured by a parameter bₕₒₚ∈{0, 1, 2, 3}, which may be indicated in a b-hop field in a frequency hopping (freqHopping) higher layer parameter, if configured. The parameter bₕₒₚ may be associated with a frequency hopping index. Otherwise, bₕₒₚ=0. When bₕₒₚ<B_{SRS}, where B_{SRS} is associated with a bandwidth allocated to an SRS, frequency hopping may be enabled. Otherwise, when bₕₒₚ≥B_{SRS}, frequency hopping may be disabled. The SRS frequency resource configuration may be associated with a number of PRBs (m_{SRS,b}) (e.g., m_{SRS,b} may be associated with a PRB allocation). The SRS frequency resource configuration may be associated with a frequency domain starting position

$$( {k}_{0}^{( pi )} ) .$$

A UE may need to sound 8 SRS ports to support an 8 Tx PUSCH transmission. The UE may sound the 8 SRS ports using one of three options. In a first option, the UE may sound the 8 SRS ports based at least in part on an SRS resource that is able to sound 8 SRS ports. The 8 SRS ports may be indexed as 1000+i, where i=0, 1, 2, . . . , 7. In a second option, the UE may sound the 8 SRS ports based at least in part on multiple SRS resources being configured in a resource set, and each with less than 8 SRS ports. In a third option, the UE may sound the 8 SRS ports based at least in part on a combination of the first option and the second option.

However, the UE may not be configured to map the 8 SRS ports to OFDM symbols of SRS resources. The UE may not be configured to consider different slot formats when mapping the 8 SRS ports to OFDM symbols of SRS resources. The UE may not be configured with a time and frequency domain configuration for the 8 SRS ports. As a result, the UE may be unable to map the 8 SRS ports to OFDM symbols of SRS resources.

In various aspects of techniques and apparatuses described herein, a UE may receive, from a network node, a time domain pattern configuration that indicates a quantity of OFDM symbols for mapping 8 SRS ports in an SRS resource. The 8 SRS ports in the SRS resource may be mapped to the quantity of OFDM symbols, as indicated by the time domain pattern configuration. The time domain pattern configuration may indicate, for a pattern index, a slot format, the quantity of OFDM symbols for mapping the 8 SRS ports, a comb number, a repetition factor, and a quantity of symbols. The time domain pattern configuration may be based at least in part on a slot format and/or a channel condition. The UE may receive the time domain pattern configuration from the network node via RRC signaling. The UE may transmit, to the network node, an SRS based at least in part on the time domain pattern configuration. The UE may transmit the SRS based at least in part on the 8 SRS ports in the SRS resource being mapped to the quantity of OFDM symbols according to the time domain pattern configuration.

In some aspects, the 8 SRS ports may be mapped to more than one OFDM symbol (e.g., multiple OFDM symbols) in one SRS resource, which may be based at least in part on an SRS resource mapping with the 8 SRS ports for an uplink codebook-based 8 Tx uplink transmission. Different slot formats may have different numbers of available symbols for SRS, so a slot-dependent time pattern may be configured via the RRC signaling to indicate the mapping of the 8 SRS ports. A time domain and frequency domain configuration, which may indicate frequency hopping and repetition, may be defined for the 8 SRS ports. Since up to 8 SRS ports may be associated with one SRS resource, the 8 SRS ports may be mapped to more than one OFDM symbol, which may allow for a larger SRS sounding power per port for better sounding quality and may minimize leakage between SRS ports due to a channel delay spread or a Doppler shift.

FIG. 8 is a diagram illustrating an example 800 associated with mapping SRS ports to a quantity of symbols, in accordance with the present disclosure. As shown in FIG. 8, example 800 includes communication between a UE (e.g., UE 120) and a network node (e.g., network node 110). In some aspects, the UE and the network node may be included in a wireless network, such as wireless network 100.

As shown by reference number 802, the UE may receive, from the network node, a time domain pattern configuration that indicates a quantity of OFDM symbols for mapping 8 SRS ports in an SRS resource. The UE may receive the time domain pattern configuration via RRC signaling. The time domain pattern configuration may indicate, for a pattern index, a slot format, the quantity of OFDM symbols for mapping the 8 SRS ports, a comb number, a repetition factor, and a quantity of symbols. The network node may indicate, to the UE, the pattern index, which may be associated with a corresponding slot format, quantity of OFDM symbols for mapping the 8 SRS ports, comb number, repetition factor, and quantity of symbols. The time domain pattern configuration may be based at least in part on the slot format and/or a channel condition. The quantity of OFDM symbols may be based at least in part on the slot format, where the quantity of OFDM symbols may be based at least in part on a quantity of uplink symbols in a slot associated with the slot format. The time domain pattern configuration may be for a periodic SRS.

In some aspects, the network node may configure, via the RRC signaling, the UE with the time domain pattern configuration, which may indicate a time domain pattern. The network node may configure the time domain pattern to indicate the quantity of OFDM symbols for mapping the 8 SRS ports in one SRS resource. The time domain pattern may be based at least in part on the slot format and/or the channel condition. The time domain pattern may be a slot-dependent time domain pattern for the 8 SRS ports. The time domain pattern may indicate the comb number (K_{TC}), the repetition factor, and the number of symbols

$$( {N}_{symb }^{SRS} ) ,$$

which may an De based at least in part on the slot format.

For example, in a special (“S”) slot, which may be associated with fewer uplink OFDM symbols as compared to an uplink (“U”) slot, a time domain pattern may indicate that 8 SRS ports map to L=1 or 2 OFDM symbols, where/indicates the quantity of OFDM symbols for mapping 8 SRS ports. In a “U” slot, which may be associated with more uplink OFDM symbols as compared to an “S” slot, a time domain pattern may indicate that the 8 SRS ports map to/=4 OFDM symbols. For example, with a “DSUUU” time division duplexing (TDD) uplink/downlink pattern, an SRS-to-OFDM symbol mapping pattern may be “01444”.

As an example, a pattern index of “1” may correspond to a slot format of “S”, one OFDM symbol for mapping 8 SRS ports (e.g., L=1), a comb number of four, a repetition factor of one, and one symbol

$$( e . g . , {N}_{symb}^{SRS} = 1 ) .$$

A pattern index of “2” may correspond to a slot format of “U”, two OFDM symbols for mapping 8 SRS ports (e.g., L=2), a comb number of one, a repetition factor of two, and four symbols

$$( e . g . , {N}_{symb}^{SRS} = 4 ) .$$

A pattern index of “3” may correspond to a slot format of “U”, two OFDM symbols for mapping 8 SRS ports (e.g., L=2), a comb number of two, a repetition factor of two, and four symbols

$$( e . g . , {N}_{symb}^{SRS} = 4 ) .$$

In some aspects, the UE may dynamically select the quantity of OFDM symbols (e.g., the UE may dynamically select L) for mapping 8 SRS ports based at least in part on the slot format. The UE may select the quantity of OFDM symbols (or L) based at least in part on a quantity of available uplink OFDM symbols in a slot. For example, when the quantity of uplink OFDM symbols in the slot is less than N1, then L=1. When the quantity of uplink OFDM symbols in the slot is greater than or equal to N1 and less than N2, then L=2. When the quantity of uplink OFDM symbols in the slot is greater than or equal to N2 and less than N3, then L=4. Further, N1, N2, and N3 may be fixed or may be configured by the network node via RRC signaling.

In some aspects, the UE may receive, from the network node and via DCI, a time domain pattern reconfiguration for an aperiodic SRS. The time domain pattern reconfiguration for the aperiodic SRS may indicate a different slot format, a different quantity of OFDM symbols, a different comb number, a different repetition factor, and/or a different number of symbols, as compared to the time domain pattern configuration. The UE may transmit, to the network node, the aperiodic SRS based at least in part on the time domain pattern reconfiguration. In some aspects, the UE may receive, from the network node and via a MAC-CE, a time domain pattern reconfiguration for a semi-persistent SRS. The time domain pattern reconfiguration for the semi-persistent SRS may indicate a different slot format, a different quantity of OFDM symbols, a different comb number, a different repetition factor, and/or a different number of symbols, as compared to the time domain pattern configuration. The UE may transmit, to the network node, the semi-persistent SRS based at least in part on the time domain pattern reconfiguration.

In some aspects, for the periodic SRS, the network node may configure the time domain pattern via the RRC signaling. For the aperiodic SRS or the semi-persistent SRS, the network node may reconfigure the time domain pattern via the DCI or the MAC-CE, respectively. In other words, the network node may reconfigure the time domain pattern for periodic SRS, via the DCI, for the aperiodic SRS. The network node may reconfigure the time domain pattern for periodic SRS, via the MAC-CE, for the semi-persistent SRS. The time domain pattern may be different depending on whether an SRS is periodic, aperiodic, or semi-persistent, and different time domain patterns may be associated with different quantities of OFDM symbols for mapping the 8 SRS ports.

As shown by reference number 804, the UE may transmit, to the network node, an SRS based at least in part on the time domain pattern configuration. The SRS may be a periodic SRS. The UE may transmit the SRS based at least in part on the 8 SRS ports in the SRS resource being mapped to the quantity of OFDM symbols according to the time domain pattern configuration. In other words, the SRS may be associated with the 8 SRS ports, which may be mapped to the quantity of OFDM symbols according to the time domain pattern configuration. In some aspects, the network node may receive the SRS from the UE. The network node may perform an . . . uplink channel estimation based at least in part on the SRS. The network node may select a precoding matrix based at least in part on the uplink channel estimation, and the network node may signal the precoding matrix to the UE.

In some aspects, the SRS may be associated with a codebook-based PUSCH transmission with 8 SRS ports, where the 8 SRS ports in the SRS resource may be mapped to one, two, or four OFDM symbols (e.g., L=1, 2, or 4). A resource mapping associated with mapping the 8 SRS ports may be the same on different OFDM symbols of the quantity of OFDM symbols, or the resource mapping associated with mapping the 8 SRS ports may be different on different OFDM symbols of the quantity of OFDM symbols. The time domain pattern configuration may include a field to indicate the quantity of OFDM symbols for sounding the 8 SRS ports. The time domain pattern configuration may include a field to indicate a quantity of SRS ports on one OFDM symbol of the quantity of OFDM symbols.

In some aspects, for an 8 Tx codebook-based PUSCH transmission, the 8 SRS ports may be mapped to L=1, 2, or 4 OFDM symbols in one SRS resource. The resource mapping, which may be based at least in part on frequency combs and cyclic shifts, may be the same on different OFDM symbols by default. Alternatively, the resource mapping may be different on different OFDM symbols by default. In some aspects, the network node may transmit, to the UE and via RRC signaling, a field to indicate the quantity of OFDM symbols (or L) for sounding 8 SRS ports. The ports on one OFDM symbol may be referred to as local SRS ports. The local SRS ports on one OFDM symbol may be represented by

$${n}_{ap}^{SRS} = \frac{{N}_{ap}^{SRS}}{L} ,$$

where L=1, 2, or 4 may refer to the quantity of OFDM symbols for sounding 8 SRS ports. In some aspects, the network node may transmit, to the UE and via RRC signaling, a field to indicate the quantity of local SRS ports on one OFDM symbol. In other words, the network node may directly indicate the quantity of OFDM symbols, or the network node may indirectly indicate the quantity of OFDM symbols may indicating the quantity of local SRS ports on one OFDM symbol.

In some aspects, an SRS count for determining a frequency domain starting position may be based at least in part on the quantity of OFDM symbols, and may be based at least in part on frequency hopping being enabled. The UE and/or the network node may determine the SRS count and/or the frequency domain starting position.

In some aspects, the 8 SRS ports may be mapped to multiple frequency hops. When frequency hopping is enabled, the SRS count (n_{SRS}) for determining the frequency-domain starting position may be based at least in part on the quantity of OFDM symbols (or L). The quantity n_{SRS} may count the quantity of SRS transmissions. For an aperiodic SRS, the SRS count may be based at least in part on the following:

$${n}_{SRS} = ⌊ \frac{{l}^{′}}{R * L} ⌋ ,$$

where l′=0, 1, . . . ,

$${N}_{symb}^{SRS} - 1 ,$$

R is the repetition factor, and

$${N}_{symb}^{SRS}$$

is the number of symbols. For a periodic SRS or a semi-persistent SRS, the SRS count may be based at least in part on the following:

$${n}_{SRS} = ( \frac{{N}_{slot}^{frame , μ} {n}_{f} + {n}_{s , f}^{μ} - {T}_{offset}}{{T}_{SRS}} ) ( \frac{{N}_{symb}^{SRS}}{R * L} ) + ⌊ \frac{{l}^{′}}{R * L} ⌋ , ( {N}_{slot}^{frame , μ} {n}_{f} + {n}_{s , f}^{μ} - {T}_{offset} ) mod {T}_{SRS} = 0 ,$$

where Nₛₗₒₜ^{frame,μ} indicates a number of slots per frame, n_{f} indicates a system frame slot number, no indicates a slot number within a frame for subcarrier spacing configuration μ, T_{offset} indicates a slot offset, and T_{SRS} indicates a periodicity (in slots).

In some aspects, the 8 SRS ports in the SRS resource may be mapped to the quantity of OFDM symbols based at least in part on an SRS-port-to-OFDM-symbol mapping. The SRS-port-to-OFDM-symbol mapping may define that SRS ports multiplexed in a same OFDM symbol are mapped to consecutive OFDM symbols and then another group of SRS ports are mapped to following OFDM symbols. The SRS-port-to-OFDM-symbol mapping may define that different groups of SRS ports are mapped to OFDM symbols in an interlaced manner.

In some aspects, an SRS port to OFDM symbol mapping may be defined. In a first option, SRS ports multiplexed to the same OFDM symbol may first be mapped to consecutive OFDM symbols, and then another group of SRS ports may be mapped to following symbols. For example, for

$${N}_{symb}^{SRS} = 8 ,$$

L=2, and K=2, and for two frequency hops, SRS port Pi=1000, 1001, 1002, and 1003 may be transmitted on symbol 0, 1, 4, and 5, respectively. Further, SRS port Pi=1004, 1005, 1006, and 1007 may be transmitted on symbol 2, 3, 6, and 7, respectively. In a second option, OFDM symbols may be mapped in the interlaced manner for different groups of SRS ports. For example, for

$${N}_{symb}^{SRS} = 8 ,$$

L=2, R=2, and for two frequency hops, SRS port Pi=1000, 1001, 1002, and 1003 may be transmitted on symbol 0, 2, 4, and 6, respectively. Further, port Pi=1004, 1005, 1006, and 1007 may be transmitted on symbol 1, 3, 5, and 7, respectively.

As indicated above, FIG. 8 is provided as an example. Other examples may differ from what is described with regard to FIG. 8.

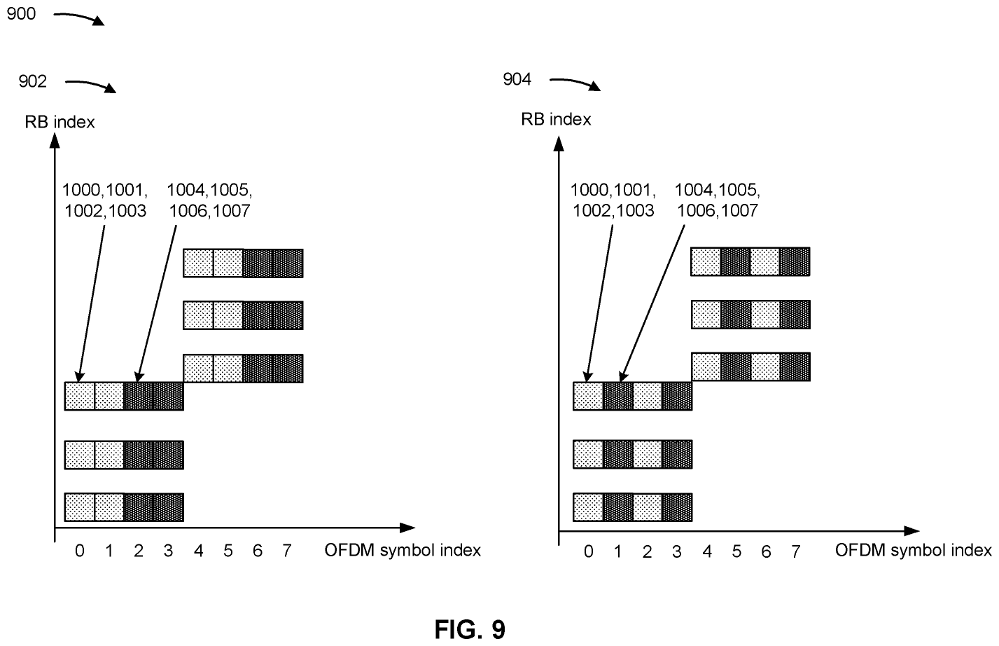

FIG. 9 is a diagram illustrating an example 900 associated with mapping SRS ports to a quantity of symbols, in accordance with the present disclosure.

As shown by reference number 902, for

$${N}_{symb}^{SRS} = 8 ,$$

L=2, and K=2, and for two frequency hops, SRS port Pi=1000, 1001, 1002, and 1003 may be transmitted on symbol 0, 1, 4, and 5, respectively, and may be associated with different resource block indexes. Further, SRS port Pi=1004, 1005, 1006, and 1007 may be transmitted on symbol 2, 3, 6, and 7, respectively, and may be associated with different resource block indexes. In other words, the SRS port Pi=1000, 1001, 1002, and 1003 may be associated with symbol 0, 1, 4, and 5, respectively, and the SRS port Pi=1004, 1005, 1006, and 1007 may be associated with symbol 2, 3, 6, and 7, respectively.

As shown by reference number 904, for

$${N}_{symb}^{SRS} = 8 ,$$

L=2, and K=2, and tor two frequency hops, SRS port Pi=1000, 1001, 1002, and 1003 may be transmitted on symbol 0, 2, 4, and 6, respectively, and may be associated with different resource block indexes. Further, port Pi=1004, 1005, 1006, and 1007 may be transmitted on symbol 1, 3, 5, and 7, respectively, and may be associated with different resource block indexes. In other words, the SRS port Pi=1000, 1001, 1002, and 1003 may be associated with symbol 0, 2, 4, and 6, respectively, and the port Pi=1004, 1005, 1006, and 1007 may be associated with symbol 1, 3, 5, and 7, respectively.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with mapping SRS ports to a quantity of symbols.

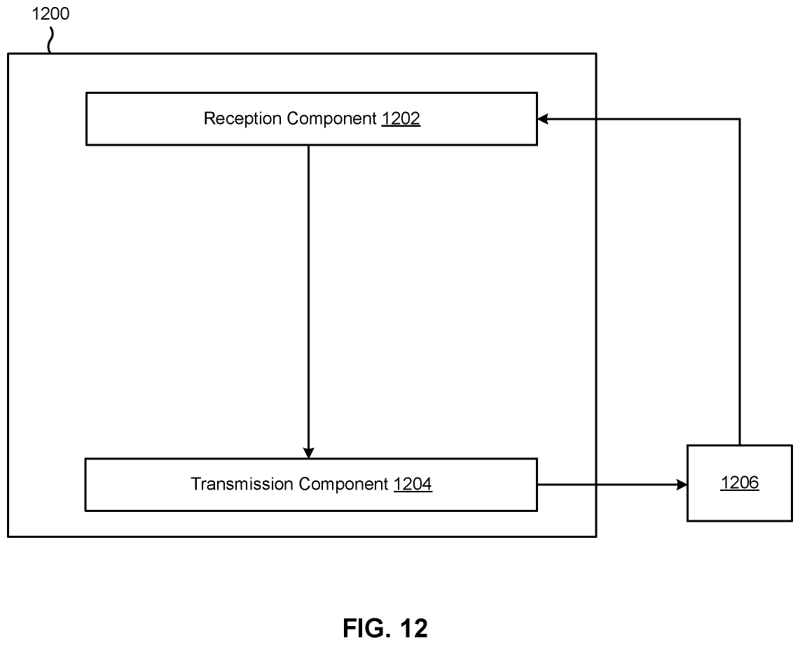

As shown in FIG. 10, in some aspects, process 1000 may include receiving, from a network node, a time domain pattern configuration that indicates a quantity of OFDM symbols for mapping 8 SRS ports in an SRS resource (block 1010). For example, the UE (e.g., using reception component 1202, depicted in FIG. 12) may receive, from a network node, a time domain pattern configuration that indicates a quantity of OFDM symbols for mapping 8 SRS ports in an SRS resource, as described above.

As further shown in FIG. 10, in some aspects, process 1000 may include transmitting, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration (block 1020). For example, the UE (e.g., using transmission component 1204, depicted in FIG. 12) may transmit, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration, as described above.

Process 1000 may include additional aspects, such as any single aspect or any combination of aspects described below and/or in connection with one or more other processes described elsewhere herein.

In a first aspect, the time domain pattern configuration indicates, for a pattern index, a slot format, the quantity of OFDM symbols for mapping the 8 SRS ports, a comb number, a repetition factor, and a quantity of symbols.

In a second aspect, alone or in combination with the first aspect, the time domain pattern configuration is based at least in part on one or more of a slot format or a channel condition.

In a third aspect, alone or in combination with one or more of the first and second aspects, the time domain pattern configuration is received via RRC signaling.

In a fourth aspect, alone or in combination with one or more of the first through third aspects, the quantity of OFDM symbols is based at least in part on a slot format, and the quantity of OFDM symbols is based at least in part on a quantity of uplink symbols in a slot associated with the slot format.

In a fifth aspect, alone or in combination with one or more of the first through fourth aspects, process 1000 includes receiving, from the network node and via DCI, a time domain pattern reconfiguration for an aperiodic SRS, and transmitting, to the network node, the aperiodic SRS based at least in part on the time domain pattern reconfiguration.

In a sixth aspect, alone or in combination with one or more of the first through fifth aspects, process 1000 includes receiving, from the network node and via a MAC . . . CE, a time domain pattern reconfiguration for a semi-persistent SRS, and transmitting, to the network node, the semi-persistent SRS based at least in part on the time domain pattern reconfiguration.

In a seventh aspect, alone or in combination with one or more of the first through sixth aspects, the SRS is associated with a codebook-based PUSCH transmission with 8 SRS ports, and the 8 SRS ports in the SRS resource are mapped to one, two, or four OFDM symbols.

In an eighth aspect, alone or in combination with one or more of the first through seventh aspects, a resource mapping associated with mapping the 8 SRS ports is a same on different OFDM symbols of the quantity of OFDM symbols.

In a ninth aspect, alone or in combination with one or more of the first through eighth aspects, a resource mapping associated with mapping the 8 SRS ports is different on different OFDM symbols of the quantity of OFDM symbols.

In a tenth aspect, alone or in combination with one or more of the first through ninth aspects, the time domain pattern configuration includes a field to indicate the quantity of OFDM symbols for sounding the 8 SRS ports.

In an eleventh aspect, alone or in combination with one or more of the first through tenth aspects, the time domain pattern configuration includes a field to indicate a quantity of SRS ports on one OFDM symbol of the quantity of OFDM symbols.

In a twelfth aspect, alone or in combination with one or more of the first through eleventh aspects, an SRS count for determining a frequency domain starting position is based at least in part on the quantity of OFDM symbols and based at least in part on frequency hopping being enabled.

In a thirteenth aspect, alone or in combination with one or more of the first through twelfth aspects, the 8 SRS ports in the SRS resource are mapped to the quantity of OFDM symbols based at least in part on an SRS-port-to-OFDM-symbol mapping, wherein the SRS-port-to-OFDM-symbol mapping defines that SRS ports multiplexed in a same OFDM symbol are mapped to consecutive OFDM symbols and then another group of SRS ports are mapped to following OFDM symbols, or the SRS-port-to-OFDM-symbol mapping defines that different groups of SRS ports are mapped to OFDM symbols in an interlaced manner.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with mapping SRS ports to a quantity of symbols.

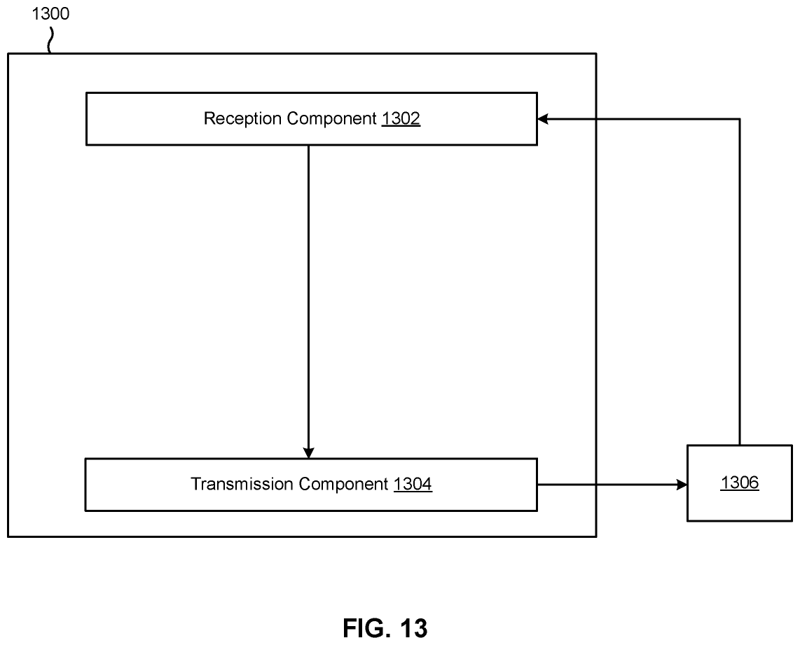

As shown in FIG. 11, in some aspects, process 1100 may include transmitting, to a UE, a time domain pattern configuration that indicates a quantity of OFDM symbols for mapping 8 SRS ports in an SRS resource (block 1110). For example, the network node (e.g., using transmission component 1304, depicted in FIG. 13) may transmit, to a UE, a time domain pattern configuration that indicates a quantity of OFDM symbols for mapping 8 SRS ports in an SRS resource, as described above.

As further shown in FIG. 11, in some aspects, process 1100 may include receiving, from the UE, an SRS based at least in part on the time domain pattern configuration, wherein the SRS is received based at least in part on the 8 SRS ports in the SRS resource being mapped to the quantity of OFDM symbols according to the time domain pattern configuration (block 1120). For example, the network node (e.g., using reception component 1302, depicted in FIG. 13) may receive, from the UE, an SRS based at least in part on the time domain pattern configuration, wherein the SRS is received based at least in part on the 8 SRS ports in the SRS resource being mapped to the quantity of OFDM symbols according to the time domain pattern configuration, as described above.

Process 1100 may include additional aspects, such as any single aspect or any combination of aspects described below and/or in connection with one or more other processes described elsewhere herein.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 8-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from a network node, a time domain pattern configuration that indicates a quantity of OFDM symbols for mapping 8 SRS ports in an SRS resource. The transmission component 1204 may transmit, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

The reception component 1202 may receive, from the network node and via DCI, a time domain pattern reconfiguration for an aperiodic SRS. The transmission component 1204 may transmit, to the network node, the aperiodic SRS based at least in part on the time domain pattern reconfiguration. The reception component 1202 may receive, from the network node and via a MAC-CE, a time domain pattern reconfiguration for a semi-persistent SRS. The transmission component 1204 may transmit, to the network node, the semi-persistent SRS based at least in part on the time domain pattern reconfiguration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 8-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit, to a UE, a time domain pattern configuration that indicates a quantity of OFDM symbols for mapping 8 SRS ports in an SRS resource. The reception component 1302 may receive, from the UE, an SRS based at least in part on the time domain pattern configuration, wherein the SRS is received based at least in part on the 8 SRS ports in the SRS resource being mapped to the quantity of OFDM symbols according to the time domain pattern configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by an apparatus of a user equipment (UE), comprising: receiving, from a network node, a time domain pattern configuration that indicates a quantity of orthogonal frequency division multiplexing (OFDM) symbols for mapping 8 sounding reference signal (SRS) ports in an SRS resource; and transmitting, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

Aspect 2: The method of Aspect 1, wherein the time domain pattern configuration indicates, for a pattern index, a slot format, the quantity of OFDM symbols for mapping the 8 SRS ports, a comb number, a repetition factor, and a quantity of symbols.

Aspect 3: The method of any of Aspects 1 through 2, wherein the time domain pattern configuration is based at least in part on one or more of a slot format or a channel condition.

Aspect 4: The method of any of Aspects 1 through 3, wherein the time domain pattern configuration is received via radio resource control signaling.

Aspect 5: The method of any of Aspects 1 through 4, wherein the quantity of OFDM symbols is based at least in part on a slot format, and wherein the quantity of OFDM symbols is based at least in part on a quantity of uplink symbols in a slot associated with the slot format.

Aspect 6: The method of any of Aspects 1 through 5, further comprising: receiving, from the network node and via downlink control information, a time domain pattern reconfiguration for an aperiodic SRS; and transmitting, to the network node, the aperiodic SRS based at least in part on the time domain pattern reconfiguration.

Aspect 7: The method of any of Aspects 1 through 6, further comprising: receiving, from the network node and via a medium access control control element, a time domain pattern reconfiguration for a semi-persistent SRS; and transmitting, to the network node, the semi-persistent SRS based at least in part on the time domain pattern reconfiguration.

Aspect 8: The method of any of Aspects 1 through 7, wherein the SRS is associated with a codebook-based physical uplink shared channel transmission with 8 SRS ports, and wherein the 8 SRS ports in the SRS resource are mapped to one, two, or four OFDM symbols.

Aspect 9: The method of any of Aspects 1 through 8, wherein a resource mapping associated with mapping the 8 SRS ports is a same on different OFDM symbols of the quantity of OFDM symbols.

Aspect 10: The method of any of Aspects 1 through 9, wherein a resource mapping associated with mapping the 8 SRS ports is different on different OFDM symbols of the quantity of OFDM symbols.

Aspect 11: The method of any of Aspects 1 through 10, wherein the time domain pattern configuration includes a field to indicate the quantity of OFDM symbols for sounding the 8 SRS ports.

Aspect 12: The method of any of Aspects 1 through 11, wherein the time domain pattern configuration includes a field to indicate a quantity of SRS ports on one OFDM symbol of the quantity of OFDM symbols.

Aspect 13: The method of any of Aspects 1 through 12, wherein an SRS count for determining a frequency domain starting position is based at least in part on the quantity of OFDM symbols and based at least in part on frequency hopping being enabled.

Aspect 14: The method of any of Aspects 1 through 13, wherein the 8 SRS ports in the SRS resource are mapped to the quantity of OFDM symbols based at least in part on an SRS-port-to-OFDM-symbol mapping, wherein the SRS-port-to-OFDM-symbol mapping defines that SRS ports multiplexed in a same OFDM symbol are mapped to consecutive OFDM symbols and then another group of SRS ports are mapped to following OFDM symbols, or wherein the SRS-port-to-OFDM-symbol mapping defines that different groups of SRS ports are mapped to OFDM symbols in an interlaced manner.

Aspect 15: A method of wireless communication performed by an apparatus of a network node, comprising: transmitting, to a user equipment (UE), a time domain pattern configuration that indicates a quantity of orthogonal frequency division multiplexing (OFDM) symbols for mapping 8 sounding reference signal (SRS) ports in an SRS resource; and receiving, from the UE, an SRS based at least in part on the time domain pattern configuration, wherein the SRS is received based at least in part on the 8 SRS ports in the SRS resource being mapped to the quantity of OFDM symbols according to the time domain pattern configuration.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive, from a network node, a time domain pattern configuration that indicates a quantity of orthogonal frequency division multiplexing (OFDM) symbols for mapping 8 sounding reference signal (SRS) ports in an SRS resource; and
transmit, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

2. The apparatus of claim 1, wherein the time domain pattern configuration indicates, for a pattern index, a slot format, the quantity of OFDM symbols for mapping the 8 SRS ports, a comb number, a repetition factor, and a quantity of symbols.

3. The apparatus of claim 1, wherein the time domain pattern configuration is based at least in part on one or more of a slot format or a channel condition.

4. The apparatus of claim 1, wherein the time domain pattern configuration is received via radio resource control signaling.

5. The apparatus of claim 1, wherein the quantity of OFDM symbols is based at least in part on a slot format, and wherein the quantity of OFDM symbols is based at least in part on a quantity of uplink symbols in a slot associated with the slot format.

6. The apparatus of claim 1, wherein the one or more processors are further configured to:
receive, from the network node and via downlink control information, a time domain pattern reconfiguration for an aperiodic SRS; and
transmit, to the network node, the aperiodic SRS based at least in part on the time domain pattern reconfiguration.

7. The apparatus of claim 1, wherein the one or more processors are further configured to:
receive, from the network node and via a medium access control control element, a time domain pattern reconfiguration for a semi-persistent SRS; and
transmit, to the network node, the semi-persistent SRS based at least in part on the time domain pattern reconfiguration.

8. The apparatus of claim 1, wherein the SRS is associated with a codebook-based physical uplink shared channel transmission with 8 SRS ports, and wherein the 8 SRS ports in the SRS resource are mapped to one, two, or four OFDM symbols.

9. The apparatus of claim 1, wherein a resource mapping associated with mapping the 8 SRS ports is a same on different OFDM symbols of the quantity of OFDM symbols.

10. The apparatus of claim 1, wherein a resource mapping associated with mapping the 8 SRS ports is different on different OFDM symbols of the quantity of OFDM symbols.

11. The apparatus of claim 1, wherein the time domain pattern configuration includes a field to indicate the quantity of OFDM symbols for sounding the 8 SRS ports.

12. The apparatus of claim 1, wherein the time domain pattern configuration includes a field to indicate a quantity of SRS ports on one OFDM symbol of the quantity of OFDM symbols.

13. The apparatus of claim 1, wherein an SRS count for determining a frequency domain starting position is based at least in part on the quantity of OFDM symbols and based at least in part on frequency hopping being enabled.

14. The apparatus of claim 1, wherein the 8 SRS ports in the SRS resource are mapped to the quantity of OFDM symbols based at least in part on an SRS-port-to-OFDM-symbol mapping, wherein the SRS-port-to-OFDM-symbol mapping defines that SRS ports multiplexed in a same OFDM symbol are mapped to consecutive OFDM symbols and then another group of SRS ports are mapped to following OFDM symbols, or wherein the SRS-port-to-OFDM-symbol mapping defines that different groups of SRS ports are mapped to OFDM symbols in an interlaced manner.

15. An apparatus for wireless communication at a network node, comprising:
a memory; and
one or more processors, coupled to the memory, configured to:
transmit, to a user equipment (UE), a time domain pattern configuration that indicates a quantity of orthogonal frequency division multiplexing (OFDM) symbols for mapping 8 sounding reference signal (SRS) ports in an SRS resource; and
receive, from the UE, an SRS based at least in part on the time domain pattern configuration, wherein the SRS is received based at least in part on the 8 SRS ports in the SRS resource being mapped to the quantity of OFDM symbols according to the time domain pattern configuration.

16. A method of wireless communication performed by an apparatus of a user equipment (UE), comprising:
receiving, from a network node, a time domain pattern configuration that indicates a quantity of orthogonal frequency division multiplexing (OFDM) symbols for mapping 8 sounding reference signal (SRS) ports in an SRS resource; and
transmitting, to the network node, an SRS based at least in part on the time domain pattern configuration, wherein the SRS is transmitted based at least in part on the 8 SRS ports in the SRS resource being mapped to the quantity of OFDM symbols according to the time domain pattern configuration.

17. The method of claim 16, wherein the time domain pattern configuration indicates, for a pattern index, a slot format, the quantity of OFDM symbols for mapping the 8 SRS ports, a comb number, a repetition factor, and a quantity of symbols.

18. The method of claim 16, wherein the time domain pattern configuration is based at least in part on one or more of a slot format or a channel condition.

19. The method of claim 16, wherein the time domain pattern configuration is received via radio resource control signaling.

20-29. (canceled)

30. A method of wireless communication performed by an apparatus of a network node, comprising:
transmitting, to a user equipment (UE), a time domain pattern configuration that indicates a quantity of orthogonal frequency division multiplexing (OFDM) symbols for mapping 8 sounding reference signal (SRS) ports in an SRS resource; and
receiving, from the UE, an SRS based at least in part on the time domain pattern configuration, wherein the SRS is received based at least in part on the 8 SRS ports in the SRS resource being mapped to the quantity of OFDM symbols according to the time domain pattern configuration.
